(19) United States
(12) Patent Application Publication
(10) Pub. No.: US 2002/0103721 A1
(43) Pub. Date: Aug. 1, 2002

(54) Dynamic catalog for on-line offering and bid system

(75) Inventors: Leland James Wiesehuegel, Austin, TX (US); Rebecca Lynn Roberts, Austin, TX (US); Charles H. Loar, Raleigh, NC (US); Carlos Joel Carvalho de Formiga Xavier, New York, NY (US)

Correspondence Address: Robert H. Frantz, P.O. Box 23324, Oklahoma City, OK, 73123-2334, US

(73) Assignee: International Business Machines Corporation, Armonk, NY (US)

(21) Appl. No.: 09/773,197

(22) Filed: Jan. 31, 2001

(51) Int. Cl. G06F 17/60

(52) U.S. Cl. 705/27

(57) ABSTRACT

A three phase, dynamic catalog generation process for creating, updating, and accessing available item descriptive information catalogs for use in conjunction with online auctions, business-to-business offering systems and retail sales. One or more databases are loaded with current descriptive information about items which may be made available for bidding or purchase, such as item part numbers, descriptions, specifications, photographs or illustrations, prices and quantities. This descriptive information is dynamically linked to a product part number. Second, each time a trader requests current descriptive information about an available part number, the databases containing descriptive information are dynamically synchronized so as to link to the most recently available information, thereby providing the trader with the most current descriptive information automatically. If the trader decides to formalize the offer, the information is copied into an offer database, thereby “capturing” the current descriptive information for the offer.

### BACKGROUND OF THE INVENTION

1. Field of the Invention

The present invention relates generally to electronic commerce and the information systems employed for online sales, auctioning and offering operations. This invention more particularly relates to technology for providing dynamic catalogs containing available product descriptive information for conducting an interactive offer and bid collection process over a computer network

2. Description of the Related Art

Prior to the advent of electronic auctioning over computer networks or electronic commerce, auctions were held in a group of gathered bidders with an auctioneer. As shown in FIG. 1, an auction (1) is conducted on behalf of a seller (2) by an auctioneer (4). The auctioneer receives a list of items to be sold and possibly a minimum and/or reserve price for those items. This list is made available to the attendees of the auction for their review. The list typically includes written descriptions of the items available, quantities available, and in some cases, photographs of the items.

During the auction, a plurality of bidders (6) place bids (5) under the guidance and control of the auctioneer (4). In some cases, multiple bidders (9) may pool (8) their bids, and the pooled bids (7) are submitted as a single bid with a combined quantity to the auctioneer (4).

The auctioneer enforces the rules of the auction, such as minimum bid price and quantities, minimum bid incrementing from the previous bid for a new bid, and time limits for placing bids. Auction bidders are typically qualified as to their ability to complete the purchase should their bid be the winning bid prior to entering the auction room.

E-commerce offers and online auctions like these are usually conducted over a specified period of time of opening and closing for bids, and are typically conducted under one of several well-known sets of rules or models.

The list of available items is typically created online by allowing the users and offerers of the items to input text descriptions of the items into a database, which is then queried by bidders to see the database entries. Thus, the available item descriptive information must be manually created and input for each and every offering which is made in the auction, even if all or some of the descriptive information is common to previous offerings made.

However, most sales offering and bid systems conducted by manufacturers of goods or service providers are conducted under a different set of procedures and processes. Turning to FIG. 2, a typical trader and broker system for offering and accepting bids is shown (20). In such a business-to-business (“B2B”) offering and bidding process (20), a manufacturer or service provider (21) will notify one or more traders (24) of available products or services, quantities, and minimum acceptable bid values (22). The trader then provides offerings (23′) to one or more brokers (25), to which the brokers may respond with bids (23). Because the manufacturer may make several offerings over time of the same product or products having very similar descriptive information, the currently available online auctioning systems would place an unacceptable burden on the manufacturer or trader to input redundant descriptive information each time a product is offered. For example, and manufacturer of computer equipment may offer in March a quantity of computers having a 750MHz microprocessor and other configuration details. Under the current methods, the manufacturer and/or trader must input all of this descriptive information into the offering “catalog” database for brokers or bidders to review. Then, if in June, the manufacturer desires to make an offer of computers with 900 MHz processors and otherwise identical descriptive information, all of the information must be completely input into the offering catalog again.

The system and method disclosed in the related application allows the traders to apply broker profiles or entitlement schema to available goods lists to produce offerings for a plurality of bidders or brokers. The list of available goods includes manufacturer identifiers and part numbers. However, the system and method disclosed do not provide for automatically gathering the most current descriptive information for those available items, such as long descriptions, full specifications, and photographs. This information must be provided by some other means, such as manual collection of the information, if it is desired to provide this information to the broker/bidders.

Therefore, there is a need in the art for a system and method to dynamically collect, maintain, update and access online catalogs of descriptive information for available items for purchase through an online offering and bidding system such as an auctioning system or B2B trader/broker system. These dynamic catalogs should include typical “real” catalog information, such as item photographs and illustrations, written descriptions, specifications, prices and quantities. This system and method should optimally be compatible with current e-commerce and online offering system technologies, including the ability to support access to the dynamic catalogs via use of a common web browser computer and software.

### BRIEF DESCRIPTION OF THE DRAWINGS

The following detailed description when taken in conjunction with the figures presented herein provide a complete disclosure of the invention.

FIG. 1 discloses the well-known arrangement of sellers, auctioneers, and bidders.

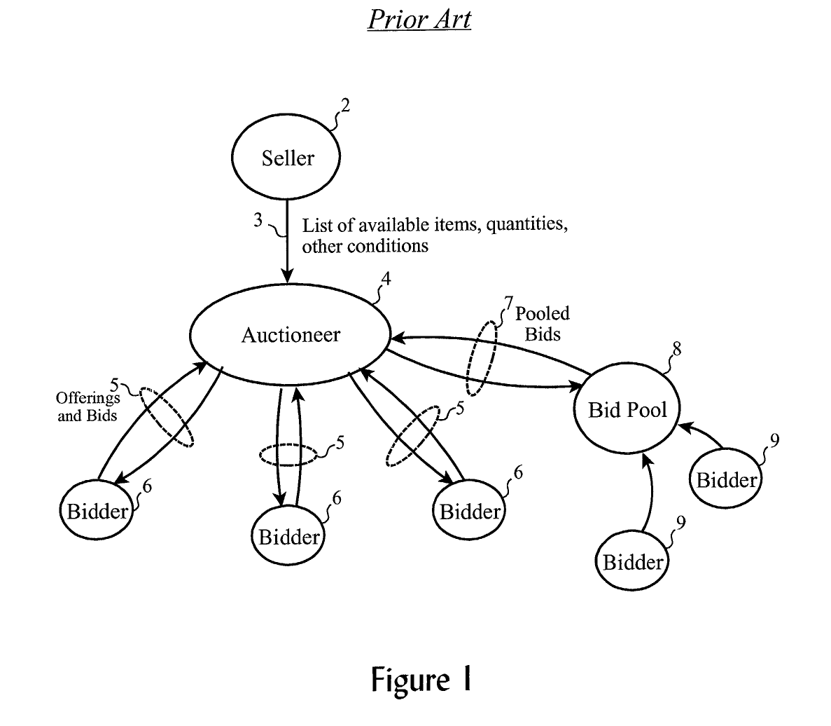

FIG. 2 shows the common business arrangement between manufacturers, service providers, traders, and brokers.

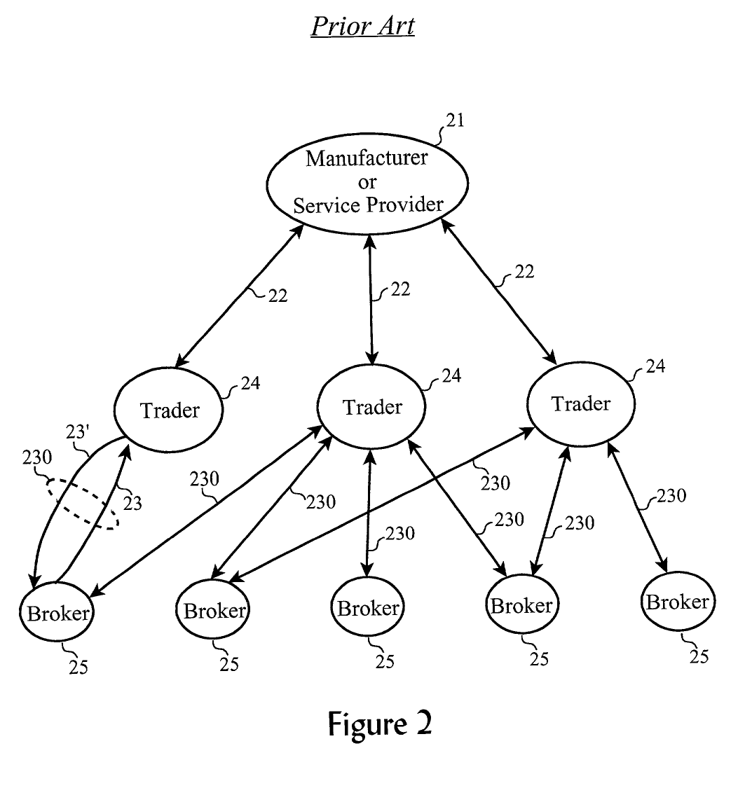

FIG. 3 shows organization of the components of the invention, and how it relates to the a generalized system architecture of the related application such that a dynamic catalog may be integrated into an online offering or auction system.

FIG. 4 illustrates the logical flow of the process of creating, maintaining, updating and accessing dynamic catalogs.

### SUMMARY OF THE INVENTION

The system and method disclosed provides a three phase, dynamic catalog generation process for creating available item descriptive information catalogs. The system and method are especially suitable for use in conjunction with online auctions and business-to-business offering systems, but may be equally useful for generating retail sales catalogs online for online shoppers. Initially, one or more databases are loaded with current descriptive information about items which may be made available for bidding or purchase, such as item part numbers, descriptions, specifications, photographs or illustrations, prices and quantities. This descriptive information is dynamically linked to the manufacturer identifier and the part number. In the second phase of the process, each time a trader requests current descriptive information about an available part number, the databases containing descriptive information are dynamically synchronized so as to link to the most recently available information, thereby providing the trader with the most current descriptive information automatically. If the trader decides to formalize the offer, the information is copied or “captured” into a database of offered items for brokers and bidders to access, thereby completing the third phase of the process. Using this system decouples the processes of updating the part information in multiple databases, searching multiple sources for the most current information, and capturing that information for use in offers.

### DETAILED DESCRIPTION OF THE INVENTION

The present method and system are preferably realized in one or more networked computers, including computer network terminals or consoles, networked database application servers, web servers, and a computer network.. The computer network consoles employed are any suitable device for accessing remote application services over a computer network, including, but not limited to, personal computer-based web browsers, wireless web browsers such as web-enabled wireless telephones and personal digital assistants (“PDA”), Internet appliances, as well as dedicated computer terminals.

The database application servers employable in the invention may be any of a wide array of available database application servers, including, but not limited to, IBM Lotus Notes servers, Oracle servers, etc. The web servers incorporated into the invention may be any suitable platform, including, but not limited to, IBM's Web Sphere product, Apache Hyper Text Transfer Protocol (“HTTP”) servers, secure HTTP servers (“HTTPS”), and the like. The computer network may include the Internet, intranets, extranets, dedicated networks such as local area networks (“LAN”) and wide area networks (“WAN”), wireless data networks, and/or any other suitable computer and data communications network.

Communications means between database application servers, computer network consoles, and web servers may include any suitable data communications protocols and media including, but not limited to, dial-up modems over telephone lines, wireless data transceivers, cable modems, Digital Subscriber Lines (“DSL”), and dedicated data communication lines.

It will be recognized by those skilled in the art that certain combinations and integrations of the features presented herein may be made without departing from the spirit and scope of the invention. Further, it will be recognized that many of the architectural details disclosed herein are disclosed under the inventor's preferred embodiment in order to enhance the robustness and reliability of the invention, but these details may not be necessary to realize the fundamental finctionality of the invention.

Throughout the disclosure given herein and the following claims, the term “broker” is used to describe a bidding party, bidder or shopper; and the term “trader” is used to describe any party who conducts the process of promoting offers to bidding parties, such as retailers, manufacturers, and wholesalers. This is nearly analogous to bidder and auctioneer in the context of a traditional auction, respectively, although the offering and bidding process provided by the invention may be used to conduct business-to-business offers as well as traditional types of auctions.

The related application describes a system and method which allows a manufacturer to offer items in an online auction-like forum, called the Interactive Offer System (“IOS”). The system and method of this related application provided the capability of “offers” containing certain available items which meet or conform to a particular bidder's profile or entitlement schema. The “master list” of all available items containing manufacturer identifiers and part numbers was contained in and obtained from a Sales Preparation System (“SPS”).

The present invention is preferably realized as an improvement to, enhancement of, or peripheral function of the system disclosed in the related application, which was referred to as an Interactive Offer Server (“IOS”). However, the invention may be employed and integrated to other online auction and offering systems, as well, and therefore is not limited to use with the system of the related patent application. It will be readily recognized by those skilled in the art that the present invention may be employed in conjunction with many other types of e-commerce systems and technologies.

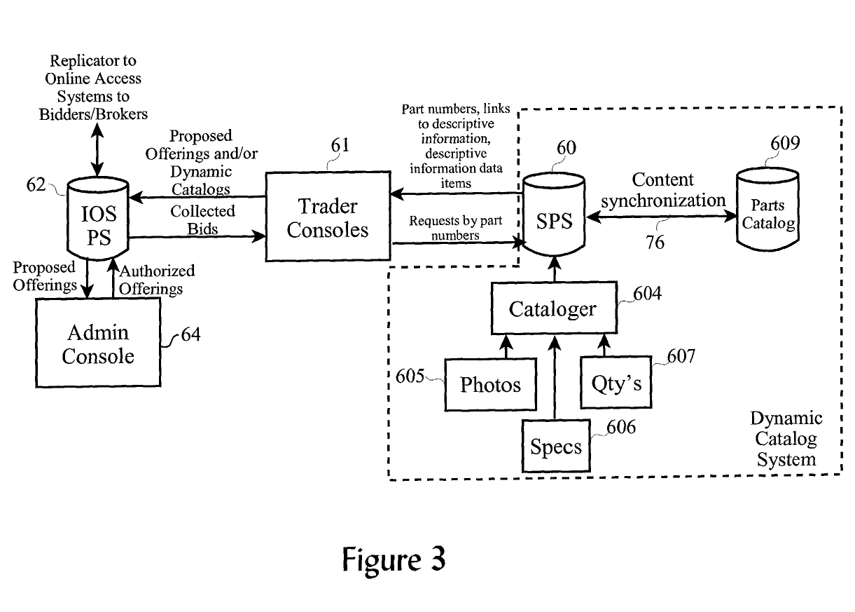

Turning to FIG. 3, the invention is shown in relationship to a portion of the IOS of the related application. The Sales Preparation System (“SPS”) (60) comprising an IBM Lotus Notes system provides available materials list to the traders via their trader consoles (61), which are networked personal computers also running Lotus Notes applications. The available materials list contains manufacturer identifiers and part numbers.

The SPS (60) contains a database of available product descriptive information indexed to part numbers, including text descriptions, specifications (606), photographs (605), prices and quantities (607) for all available items.

Normally, a trader would use his or her trader console (61) to obtain available part numbers and related descriptive information, would prepare offerings, and then post those offerings in the IOS database (62). Eventually, according to the method disclosed in the related application, the offerings of the IOS are made available to online brokers and bidders for consideration and bidding.

According to the preferred embodiment, the invention integrates to the current IOS via the SPS. A cataloger (604) collects or receives current product descriptive information and places it into the SPS database as it is available, as is it may need to be updated. Initially, if no descriptive information is contained in SPS for a particular part number, the cataloger (604) may be tasked to photograph the item, find current specifications for the item, etc. These descriptive information items (605, 606 and 607) are then loaded into SPS to form an initial set of descriptive information which is dynamically linked to the part number and manufacturer identifier.

Whenever new information is available, such as a new photograph showing a change in the product model, this can be entered by the cataloger and dynamically linked to the part number so as to replace the previously linked photograph in all instances, lots, and offers.

A particular part number or item number may be represented by multiple sets of information, such as several descriptions in different languages, several different prices, or even different photographs suitable for marketing to brokers, bidders or shopper of varying demographics.

Further, a parts catalog database (609) is linked to the SPS because it too may contain descriptive information about the available part numbers. Finally, a database synchronization script is provided on the SPS which synchronizes the content of the parts catalog (609) with the SPS database. For example, if when the script is run a descriptive item, such as a photograph, is found in one of the databases but not the other, that item will be copied to database which does not yet contain it. Also, if the two databases contain similar descriptive items, but one database's item is newer, the newer item(s) will be copied to replace the older item(s) in the other database. This script can be set to run periodically, such as once per day, and/or upon an event, such as receipt of a request for information regarding a particular part number. Also, database synchronization can be performed among multiple databases, not just two databases, so that this particular invention can be used to create dynamic catalogs which draw information from multiple databases and servers dynamically.

General abilities to filter content of databases are available in the Lotus Notes system, which a motivating factor for its use in the preferred embodiment. The synchronization process, however, could be implemented as a script or program to access and synchronize other types of databases, as well.

The trader may then use a trader console (61) to access the most current descriptive information by supplying requests containing part numbers to SPS (60). Preferably, SPS executes the synchronization function or script to link to the most current descriptive information in the parts catalog (609), SPS, and any other linked databases. Then, this current descriptive information is returned to the requester or trader via the trader console (61).

When the trader has finalized the offer, the current descriptive information is copied to the IOS (62) to be made available to brokers and bidders, thus capturing the currently available information about the offered products.

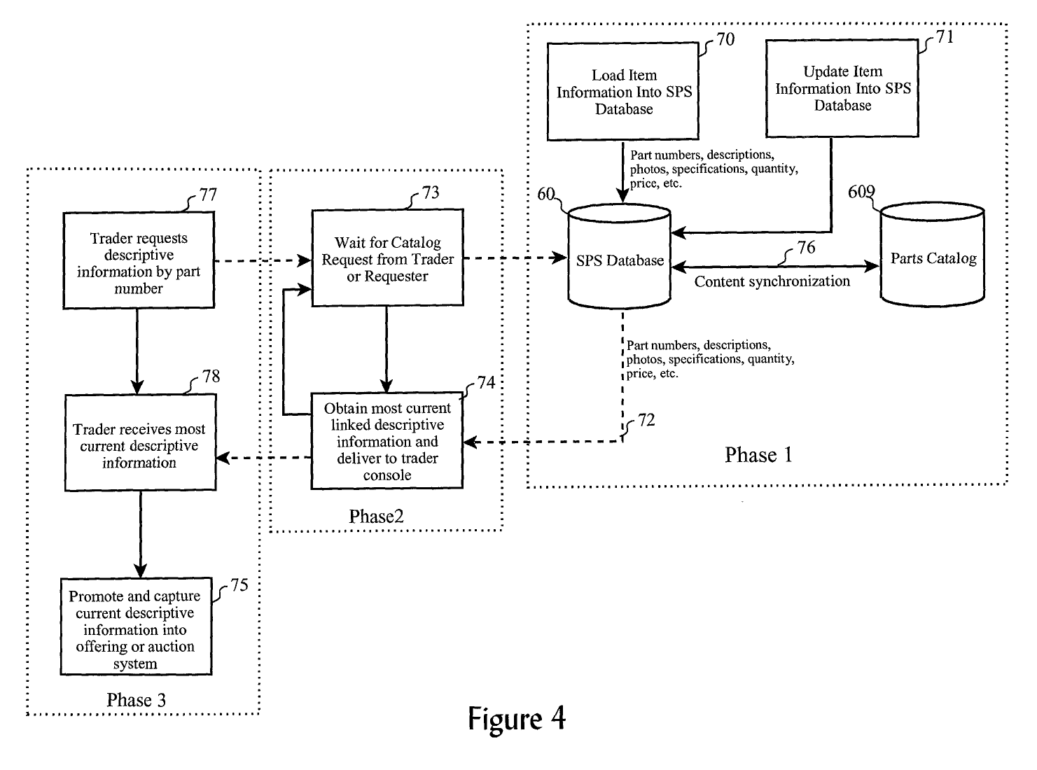

Turning now to FIG. 4, the logical flow of the method of the invention is presented. Initially, a cataloger loads (70) descriptive information such as photographs, text descriptions, specifications, quantities, etc., into the SPS database (60) and links that information to one or more part numbers. At any time that new information is available, the cataloger may update (71) the linked information in the SPS database (60).

Further, the SPS database (60) may automatically synchronize (76) its contents with the contents of other databases, such as the parts database (609), on a periodic basis, such as daily.

The SPS waits (73) for receipt of a request from a trader for descriptive information related to specific part numbers and/or manufacturer identifiers. The SPS then preferably initiates a synchronization (76) of the SPS database (60) contents with the contents of the other linked databases such that any information updated since the last synchronization will be linked dynamically to the part number(s) requested. This most-current descriptive information is then transmitted (74) to the trader to fulfill his request for descriptive information (78).

The trader, then, may formalize the offering by promoting (75) the offer including the descriptive information to an online offering or auctioning system such as the IOS. At this point, the descriptive information is captured and copied into the online offering system so that it may be made available to a broker or bidder.

Thus, through use of the system and method disclosed herein, an operator of an online offering or auction system may access catalogs of descriptive information regarding available items, said descriptive information being dynamically updated and linked to the very latest available descriptive information. This frees the online offering or auctioning system operator from manually gathering this information and from having to generate redundant information from one offer to another. Further, the process of updating the online catalog of descriptive information is decoupled from the process of creating offers such that a cataloger may simply update the catalog information as it becomes available, being assured by the system and method that it will be automatically included in future offers as required.

It will be understood by those skilled in the art and from the foregoing description that various modifications and changes may be made in the preferred embodiment of the present invention without departing from its spirit and scope. It is intended that this description is for purposes of illustration only and should not be construed in a limiting sense. The scope of this invention should be defined by the following claims.

What is claimed is

1. A method for providing electronic catalogs of information sets regarding available products for bid or purchase, said information sets containing descriptive and illustrative data items for said available products, said method comprising the steps of:
providing at least two repositories of information sets and data items;
dynamically linking said information sets and data items to part numbers for available products; and
synchronizing contents of said repositories such that all information sets and data items within all repositories represent full information sets of most recently created data items.

2. The method as set forth in claim 1 wherein said step of synchronizing is performed on a periodic basis.

3. The method as set forth in claim 1 wherein said step of synchronizing is performed responsive to a request for said information sets in any of the repositories.

4. The method as set forth in claim 1 further comprising the step of providing a list to a user, said list having part numbers and dynamic links to said information sets and data items associated with said listed part numbers.

5. The method as set forth in claim 1 further comprising the step of saving a copy of an information set linked to a part number such that said saved copy is statically linked to said most recently created data items.

6. A computer readable medium containing program code for providing electronic catalogs of information sets regarding available products for bid or purchase in a computer system, said information sets containing descriptive and illustrative data items for said available products, said program code when executed by a computer causing the computer to perform the steps of:
providing at least two repositories of information sets and data items;
dynamically linking said information sets and data items to part numbers for available products; and
synchronizing contents of said repositories such that all information sets and data items within all repositories represent full information sets of most recently created data items.

7. The computer readable medium as set forth in claim 6 wherein said program code for synchronizing is adapted to perform synchronization on a periodic basis.

8. The computer readable medium as set forth in claim 6 wherein said program code for synchronizing is adapted to perform synchronization responsive to a request for said information sets in any of the repositories.

9. The computer readable medium as set forth in claim 6 further comprising program code for performing the step of providing a list to a user, said list having part numbers and dynamic links to said information sets and data items associated with said listed part numbers.

10. The computer readable medium as set forth in claim 6 wherein said program code for further comprises program code for saving a copy of an information set linked to a part number such that said saved copy is statically linked to said most recently created data items.

11. A dynamic catalog in a computer system comprising:
at least two computer-readable repositories of descriptive data items;
a plurality of dynamic links between descriptive data items and product part numbers; and
a repository synchronizer which dynamically updates links to descriptive data items adapted to replace links to older data items with links to newer data items, and adapted to add links to data items which were not previously available.

12. The dynamic catalog as set forth in claim 11 wherein said repository synchronizer is adapted to replace and add links on a timed basis.

13. The dynamic catalog as set forth in claim 11 wherein said repository synchronizer is adapted to replace and add links responsive to a request for information from said repositories.

14. The dynamic catalog as set forth in claim 11 further comprising a offer description creator adapted to capture or copy dynamically linked data items to a part number into a second set of descriptive data items which are statically related to said part number.

15. The dynamic catalog as set forth in claim 11 further comprising an offer list creator adapted to create a list of part numbers associated with dynamic links to said data items.
